(19) United States
(12) Patent Application Publication
(10) Pub. No.: US 2016/0195801 A1
(43) Pub. Date: Jul. 7, 2016

(54) Projector

(71) Applicants: QISDA OPTRONICS (SUZHOU) CO., LTD., Suzhou (CN); QISDA CORPORATION, Taoyuan City (TW)

(72) Inventor: Chih-Shiung Chien, Taoyuan City (TW)

(21) Appl. No.: 14/981,968

(22) Filed: Dec. 29, 2015

(30) Foreign Application Priority Data
Jan. 7, 2015 (TW) 104100446

(51) Int. Cl. G03B 21/20; G03B 21/00

(52) U.S. Cl. CPC G03B 21/2066; G03B 21/008

(57) ABSTRACT

A projector includes a light source, a digital micro-mirror device (DMD), a lens, a first prism, and a second prism. The light source is used for emitting an incident light. The DMD has a first side and a second side. The DMD is used for receiving and reflecting the incident light as an image light. The lens is used for receiving the image light. The first prism is disposed between the light source and the DMD, including a first plane facing the light source for receiving the incident light, a second plane adjoining the first plane for reflecting the incident light to the DMD, and a third plane paralleled to the DMD. The second prism is disposed between the first prism and the lens, including a fourth plane paralleled to the second plane, and a fifth plane adjoined the fourth plane and facing the lens.

### BACKGROUND OF THE INVENTION

1. Field of the Invention

The present invention illustrates a projector, and more particularly, the projector with two-axis tilting digital micro-mirror device.

2. Description of the Prior Art

The conventional projector can project micro-images to a huge screen by a digital micro-mirror device (DMD). Further, since the conventional projector provides sufficient brightness, the image data can be displayed and then shared to everyone.

FIG. 1 illustrates a structure of a conventional projector 50. As shown in FIG. 1, the conventional projector 50 includes a digital micro-mirror device 10, a total internal reflection (TIR) prism set 11, a reflecting mirror (reflector) 12, a lens module 13, and a light pipe 14. For illustrating viewing direction explicitly, 3 perpendicular axes of Cartesian coordinate are represented on the right hand side in FIG. 1. Specifically, the viewing direction on X-axis is a direction from an origin point to the right side. The viewing direction on Y-axis is a direction from the origin point to the underside. The viewing direction on Z-axis is an incident direction on X-Y plane. In the conventional projector 50, an incident light passes the lens module 13 through the light pipe 14 and is reflected to the TIR prism set 11 by the reflecting mirror 12. Finally, the incident light is reflected as an image light by the digital micro-mirror device 10 and then projected to the screen. However, the digital micro-mirror device 10 can only receive the incident light with oblique incident direction because of the physical limitation of the digital micro-mirror device 10. Thus, the disposition between the TIR prism set 11 and the digital micro-mirror device 10 introduces an inclination angle (i.e., such as 45 degrees of angle). As a result, the volume of the conventional projector 50 is bounded by the inclination angle. Since the volume reduction is the major issue of the projector design, conventional projector 50 with big volume becomes inconvenient and thereby losses of competitiveness.

Thus, to develop a projector with small volume is important.

### SUMMARY OF THE INVENTION

In an embodiment of the present invention, a projector is disclosed. The projector includes a light source, a digital micro-mirror device, a lens, a first prism, and a second prism. The light source is used for emitting an incident light. The digital micro-mirror device has a first side in a first direction and a second side in a second direction perpendicular to the first direction, wherein the first side is longer than the second side, the digital micro-mirror device receives and reflects the incident light as an image light, and the image light is transmitted along a third direction perpendicular to the first direction. The lens is used for receiving and projecting the image light. The first prism is disposed between the light source and the digital micro-mirror device for receiving and transmitting light. The first prism includes a first plane, a second plane, and a third plane. The first plane facing the light source is used for receiving the incident light. The second plane is adjoined the first plane for reflecting the incident light to the digital micro-mirror device. The third plane is parallel to the digital micro-mirror device and is adjoined the first plane by an adjoining side, wherein the adjoining side is parallel to the first side. The second prism is disposed between the first prism and the lens for receiving and transmitting the image light. The second prism includes a fourth plane and a fifth plane. The fourth plane is parallel to the second plane. The fifth plane is adjoined the fourth plane and faces the lens.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a structure of a conventional projector.

FIG. 2 illustrates a structure of a projector according to the embodiment of the present invention.

FIG. 3 illustrates a structure of two prisms of the projector in FIG. 2 according to the embodiment of the present invention.

FIG. 4 illustrates a side view of the projector in FIG. 2 according to the embodiment of the present invention.

FIG. 5 illustrates a simulation result of light paths of a projector according to another embodiment of the present invention.

### DETAILED DESCRIPTION

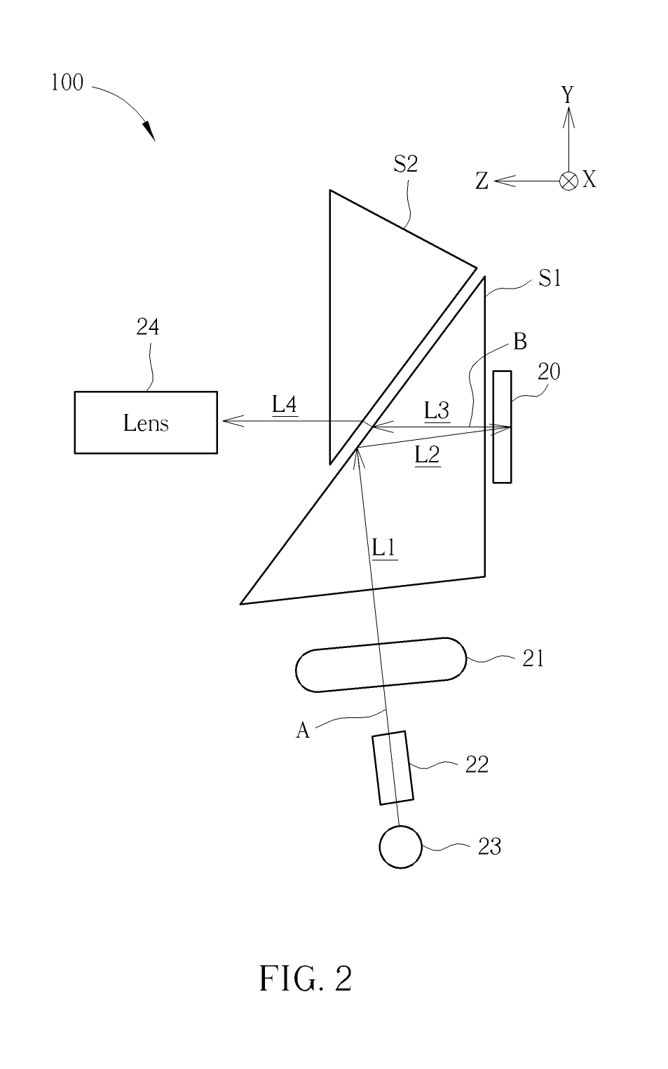

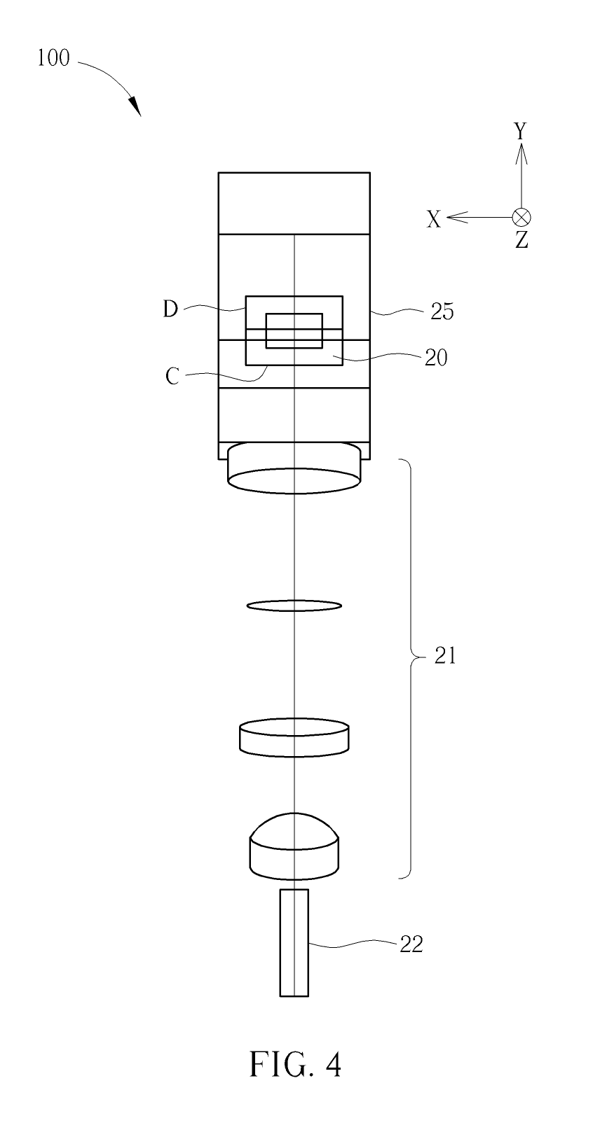

FIG. 2 illustrates a structure of a projector 100 according to the embodiment of the present invention. As shown in FIG. 2, the projector 100 includes a digital micro-mirror device 20, a lens module 21, a light pipe 22, a light source 23, a lens 24, a first prism S1, and a second prism S2. The light source 23 is used for emitting an incident light A. The digital micro-mirror device 20 is a rectangular-shaped flat device. Specifically, the digital micro-mirror device 20 has a plurality of micro-mirrors for reflecting the incident light A to an image light B. The digital micro-mirror device 20 has a long side C in a first direction and a short side D in a second direction perpendicular to the first direction (i.e., see FIG. 4). In the embodiment, the digital micro-mirror device 20 is a two-axis tilting digital micro-mirror device (i.e., TRP (Tilt & Roll Pixel) DLP® Pico™ chipset). Particularly, all micro-mirrors can be tilted to ON-state and OFF-state. When the micro-mirrors are operated on ON-state, each micro-mirror is sequentially tilted 12 degrees on two diagonal axes. Thus, the incident light A is reflected as the image light B with 34˜36 degrees of angle equivalently. The lens 24 is used for receiving the image light B. The first prism S1 and the second prism S2 are disposed among the lens module 21, the digital micro-mirror device 20, and the lens 24 for receiving the incident light A from the lens module 21, reflecting the incident light A to the digital micro-mirror device 20, and transmitting the image light B to the lens 24. In the projector 100, after the light source 23 emits the incident light A, the incident light A is transmitted to the lens module 21 through the light pipe 22. The incident light A is further transmitted to the first prism S1 along a light path L1. Then, the incident light A is reflected (i.e., total internal reflection) to the digital micro-mirror device 20 along a light path L2 inside the first prism S1. The micro-mirror device 20 reflects the incident light A as the image light B. The image light B is transmitted back to the first prism S1 along a light path L3. In the following, the image light B passes through the first prism S1 and the second prism S2 progressively and is transmitted to the lens 24 along a light path L4. The detailed expression of light transmission process is illustrated later. For illustrating viewing direction explicitly, 3 perpendicular axes of Cartesian coordinate are represented on the upper right hand side in FIG. 2. Specifically, the viewing direction on X-axis is an incident direction on Y-Z plane. The viewing direction on Y-axis is a direction from an origin point to the upside. The viewing direction on Z-axis is a direction from the origin point to the left side. In the embodiment, a space exists between the first prism S1 and the second prism S2. Another space also exists between the first prism S1 and the digital micro-mirror device 20. Although two spaces are introduced in this embodiment, the present invention is not limited by the two spaces. For example, in other embodiments, no space is introduced between the first prism S1 and the second prism S2, and between the first prism S1 and the digital micro-mirror device 20. The structure of the first prism S1 and the second prism S2 in the projector 100 and the light transmission process are illustrated below.

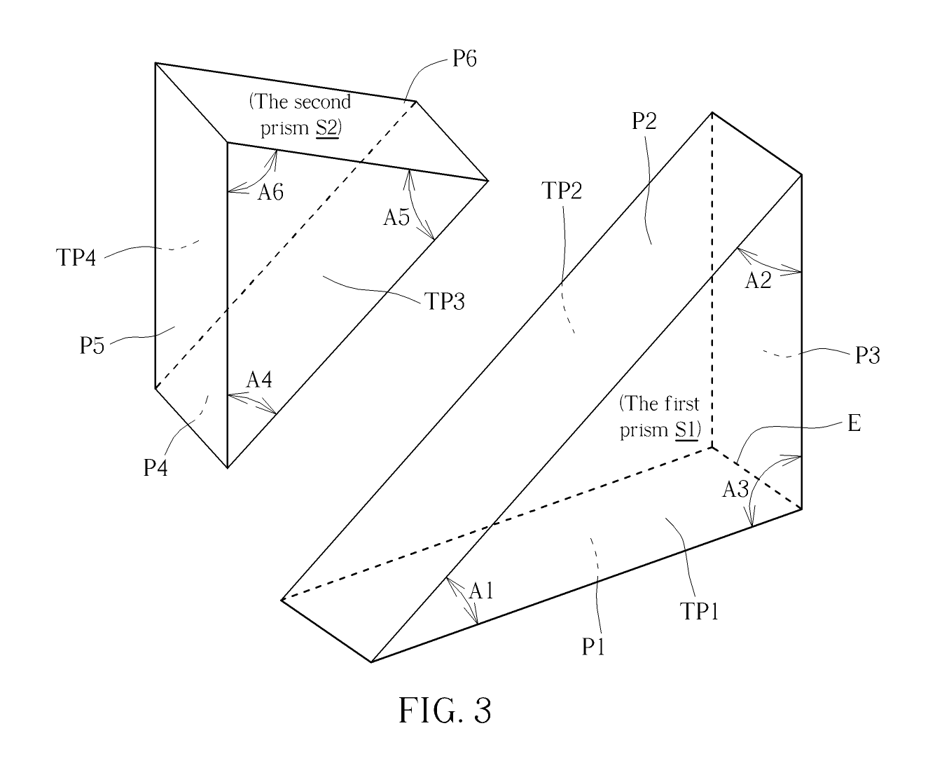

FIG. 3 illustrates a structure of the first prism S1 and the second prism S2 in the projector 100 according to an embodiment of the present invention. In this embodiment, the first prism S1 is a triangular prism with 5 planes. The first prism S1 includes a first triangular plane TP1, a second triangular plane TP2, a first plane P1, a second plane P2, and a third plane P3. A first angle A1 is located between the first plane P1 and the second plane P2. A second angle A2 is located between the second plane P2 and the third plane P3. A third angle A3 is located between the third plane P3 and the first plane P1. In some embodiments, the third angle A3 is greater than the first angle A1 and the second angle A2. For example, the first angle A1 can be 52.31 degrees. The second angle A2 can be 29.50 degree. The third angle A3 can be 98.19 degree. The second prism S1 is also a triangular prism with 5 planes. The second prism S2 includes a third triangular plane TP3, a fourth triangular plane TP4, a fourth plane P4, a fifth plane P5, and a sixth plane P6. A fourth angle A4 is located between the fourth plane P4 and the fifth plane P5. A fifth angle AS is located between the fourth plane P4 and the sixth plane P6. A sixth angle A6 is located between the fifth plane P5 and the sixth plane P6. In some embodiments, the fourth angle A4 can be equal to the second angle A2. For example, the fourth angle A4 can be 29.50 degrees. The fifth angle AS can be 95.50 degrees. The sixth angle A6 can be 55.50 degrees. In some embodiments, the first prism 51 and the second prism S2 have to satisfy the following conditions. The third plane P3 of the first prism 51 is parallel to the fifth plane P5 of the second prism S2. The second plane P2 of the first prism S1 is parallel to the fourth plane P4 of the second prism S2. Further, the third plane P3 of the first prism S1 is parallel to the digital micro-mirror device 20 in FIG. 2 (i.e., on Y-axis). The adjoining side E is introduced between the third plane P3 and the first plane P1 of the first prism S1. Specifically, the adjoining side E is parallel to the digital micro-mirror device 20 (i.e., on X-axis).

In the following, the transmission processes of the incident light A and the image light B in FIG. 2 and FIG. 3 are illustrated. In FIG. 2, the light pipe 22 receives the incident light A emitted from the light source 23. In some embodiments, the light pipe 22 can be a wedge-shaped light pipe. The wedge-shaped light pipe is defined that the measure of caliber for receiving the incident light A is greater than the measure of caliber for outputting the incident light A. Thus, the coupling efficiency of the light pipe 22 can be improved. The incident light A passes through the light pipe 22 and the lens module 21 progressively. The function of the lens module 21 is used for concentrating the beam from the incident light A by light focusing characteristics. By doing so, the incident light A can be projected on the digital micro-mirror device 20 precisely. In some embodiments, the lens module 21 comprises at least one lens. An equivalent focal length of the lens module 21 may be 80 mm˜82 mm. The incident light A passes through the lens module 21 and then reaches to the first plane P1 of the first prism S1 in accordance with vertical incidence. In other words, the transmitted direction of the incident light A is parallel to the direction of a normal vector of the first plane P1. The incident light A is transmitted along the light path L1 inside the first prism S1. Then, the incident light A is reflected by the second plane P2 of the first prism S1. Here, the reflection is a total internal reflection so that the incident light A is transmitted back to the same medium (i.e., the first prism S1) after the incident light A is reflected by the second plane P2. Then, the incident light A is transmitted along the light path L2. Finally, the incident light A reaches the digital micro-mirror device 20 by passing off the third plane P3 of the first prism S1. Here, the digital micro-mirror device 20 has the long side C on X-axis and the short side D on Y-axis. The adjoining side E between the third plane P3 and the first plane P1 of the first prism S1 is parallel to the long side C of the digital micro-mirror device 20. Thus, the beam of the incident light A being transmitted to the digital micro-mirror device 20 on X-Y plane can be regarded as the beam of the incident light A being transmitted to the long side C of the digital micro-mirror device 20 (see FIG. 4) without any additional inclination angle (i.e., a straight line in FIG. 4). In some embodiments, since the digital micro-mirror device 20 is a two-axis tilting digital micro-mirror device (i.e., TRP (Tilt & Roll Pixel) DLP® Pico™ chipset), each micro-mirror can be sequentially tilted 12 degrees on two diagonal axes. As a result, after the incident light A is transmitted to the digital micro-mirror device 20 along the light path L2, the incident light A is reflected as the image light B with 34˜36 degrees of angle therebetween. Further, the image light B is transmitted along the light path L3 and then passes off the third plane P3 and the second plane P2 of the first prism S1. Here, the light path L3 may be perpendicular to the third plane P3. The image light B is refracted by a space (air) between the first prism S1 and the second prism S2. Then, the image light B passes off the fourth plane P4 and the fifth plane P5 of the second prism S2 along the light path L4. Specifically, the fifth plane P5 of the second prism S2 is parallel to the third plane P3 of the first plane S1. The light path L4 is parallel to the light path L3. The image light B is perpendicularly transmitted to the fifth plane P5 of the second prism S2. Thus, the image light B passes through the fifth plane P5 without any reflection. Finally, the image light B is received by the lens 24.

In the projector 100, the range of the digital micro-mirror device 20 for receiving the incident light A to the range of the light pipe 22 ratio is about 1.65˜1.85. Equivalently, the magnification of an optical mechanical system formed by the light pipe 22, the lens module 21, the prisms S1,S2, and the digital micro-mirror device 20 is about 1.65˜1.85. Further, the aperture of the lens 24 is F1.7. However, the present invention is not limited by the specific projective magnification and aperture. For example, the magnification and the aperture can be any values in other embodiments.

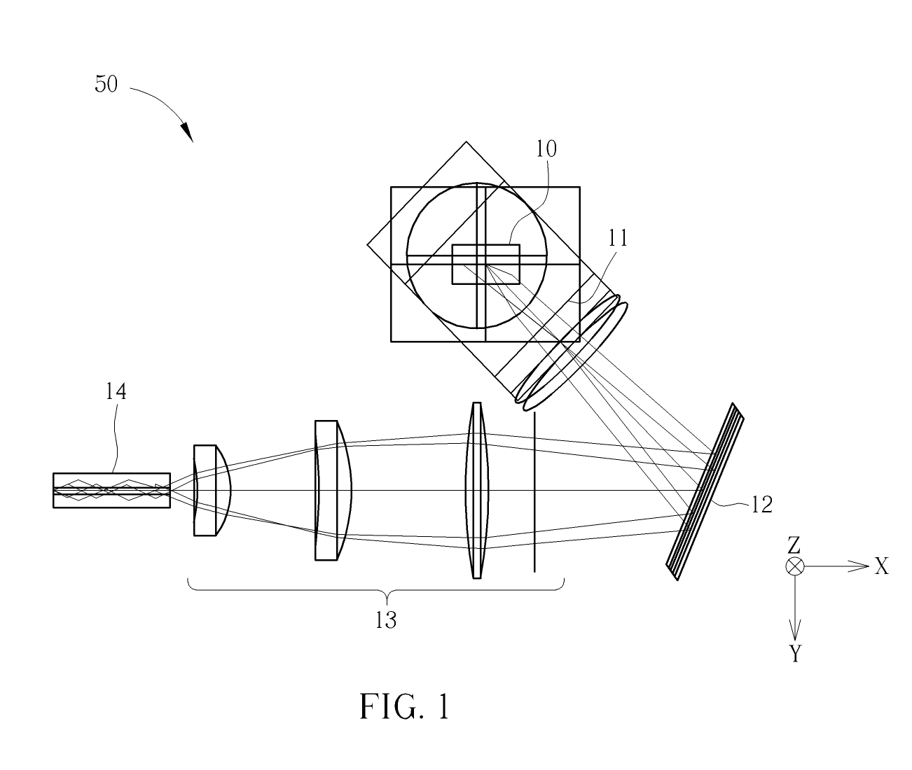

FIG. 4 illustrates a side view of the projector 100 in FIG. 2 according to an embodiment of the present invention. As shown in FIG. 4, the side view of the projector 100 includes a total internal reflection (TIR) prism set 25, a digital micro-mirror device 20, a lens module 21, and a light pipe 22. For illustrating viewing direction explicitly, 3 perpendicular axes of Cartesian coordinate are represented on the upper right hand side in FIG. 4. Specifically, the viewing direction on X-axis is a direction from an origin point to the left side. The viewing direction on Y-axis is the direction from the origin point to the upside. The viewing direction on Z-axis is an incident direction on X-Y plane. The structure of the TIR prism set includes the first prism S1 and the second prism S2 illustrated in FIG. 3. The digital micro-mirror device 20 is a two-axis tilting digital micro-mirror device (i.e., TRP (Tilt & Roll Pixel) DLP® Pico™ chipset). The adjoining side E between the third plane P3 and the first plane P1 of the first prism S1 is parallel to the long side C of the digital micro-mirror device 20 (see FIG. 3 and FIG. 4). The incident light A is transmitted to the long side C of the digital micro-mirror device 20 on X-Y plane. Thus, unlike the conventional projector 50 in FIG. 1 that the disposition between the TIR prism set 11 and the digital micro-mirror device 10 introduces an additional inclination angle, no additional inclination angle is introduced between the TIR prism set 25 and the digital micro-mirror device 20 of the projector 100 in FIG. 4. Particularly, in the viewing direction on Z-axis, the transmitted directions of the incident light A and the image light B are consistent in a straight line through the light pipe 22, the lens module 21, the TIR prism set 25, and the digital micro-mirror device 20 (i.e., the incident light A and the image light B are reflected on Y-Z plane so that they can be observed as a straight line transmission in the viewing direction on Z-axis, thereby leading no additional inclination angle). In FIG. 4, since no inclination angle is introduced between the TIR prism set 25 and the digital micro-mirror device 20, the volume of the projector 100 can be reduced.

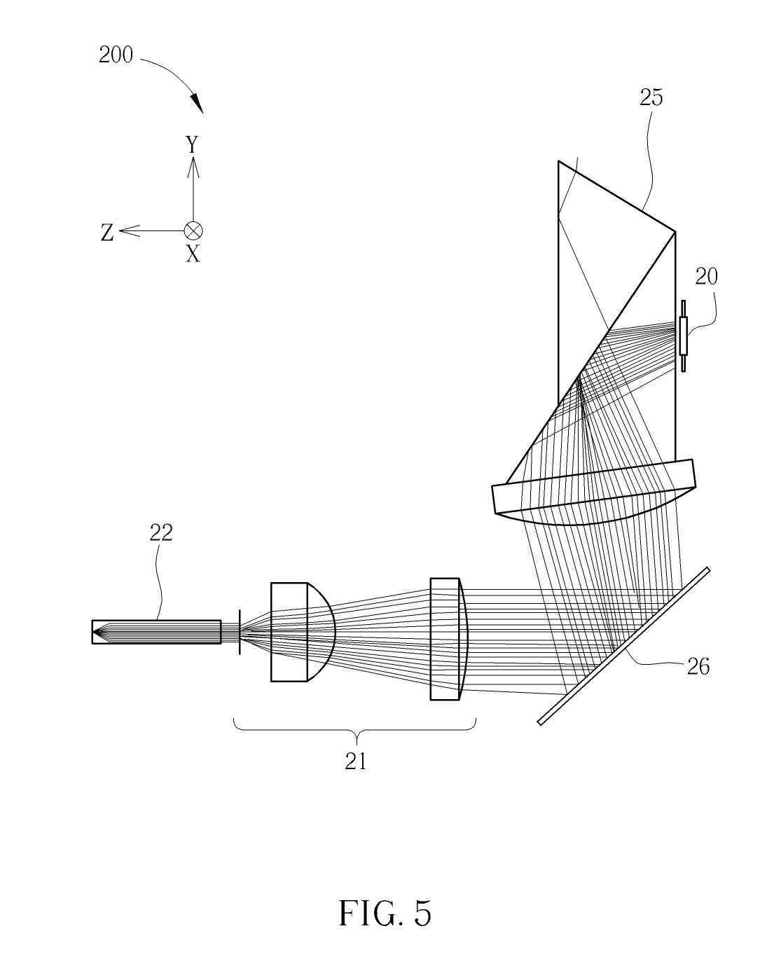

FIG. 5 illustrates a simulation result of the incident light A of a projector 200 according to another embodiment of the present invention. As shown in FIG. 5, the structure of the projector 200 includes a TIR prism set 25, a digital micro-mirror device 20, a lens module 21, a light pipe 22, and a reflector 26. The projector 200 is similar to the projector 100. The difference is that the reflector 26 is introduced in the projector 200 for reflecting the incident light A from the lens module 21 to the TIR prism set 25. By using the reflector 26, the volume of the projector 200 can be further reduced. For illustrating viewing direction explicitly, 3 perpendicular axes of Cartesian coordinate are represented on the upper left hand side in FIG. 5. Specifically, the viewing direction on X-axis is an incident direction on Y-Z plane. The viewing direction on Y-axis is a direction from an origin point to the upside. The viewing direction on Z-axis is a direction from the origin point to the left side. In FIG. 5, the incident light A is transmitted to the lens module 21 through the light pipe 22. The lens module 21 concentrates the beam from the incident light A and then transmits the incident light A to the digital micro-mirror device 20 according to the light paths illustrated in FIG. 2 and FIG. 5. Specifically, some light leakage may occur during the imaging and reflecting process. However, comparing with the incident light A, the intensity of light leakage is minor and can be ignored.

To sum up, a projector is disclosed in the present invention. The idea is to use a two-axis tilting digital micro-mirror device for volume reduction. By doing so, no additional inclination angle is required between the TIR prism set and the digital micro-mirror device of the projector. As a result, the volume of the projector in the present invention can be reduced, thereby increasing the convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projector comprising:
a light source for emitting an incident light;
a digital micro-mirror device having a first side in a first direction and a second side in a second direction perpendicular to the first direction, wherein the first side is longer than the second side, the digital micro-mirror device receives and reflects the incident light as an image light, the image light is transmitted along a third direction perpendicular to the first direction;
a lens for receiving and projecting the image light; and
a first prism disposed between the light source and the digital micro-mirror device for receiving and transmitting light, the first prism comprising:
a first plane facing the light source for receiving the incident light;
a second plane adjoined the first plane for reflecting the incident light to the digital micro-mirror device; and
a third plane paralleled to the digital micro-mirror device and adjoined the first plane by an adjoining side, wherein the adjoining side is parallel to the first side; and
a second prism disposed between the first prism and the lens for receiving and transmitting the image light, the second prism comprising:
a fourth plane paralleled to the second plane; and
a fifth plane adjoined the fourth plane and facing the lens.

2. The projector of claim 1, wherein the digital micro-mirror device is a two-axis tilting digital micro-mirror device.

3. The projector of claim 1, wherein the fifth plane is parallel to the third plane.

4. The projector of claim 1, further comprising:
a first angle located between the first plane and the second plane;
a second angle located between the second plane and the third plane; and
a third angle located between the third plane and the first plane;
wherein the third angle is greater than the first angle and the second angle.

5. The projector of claim 1, wherein the direction of the incident light transmitted to the first plane is perpendicular to the first plane.

6. The projector of claim 1, wherein the third direction is perpendicular to the fifth plane.

7. The projector of claim 1, wherein a space exists between the second plane and the fourth plane.

8. The projector of claim 1, wherein a space exists between the digital micro-mirror device and the third plane.

9. The projector of claim 1, further comprising:
a lens module disposed between the light source and the first plane.

10. The projector of claim 9, wherein an equivalent focal length of the lens module is 80 mm˜82 mm.

11. The projector of claim 9, further comprising:
a light pipe disposed between the light source and the lens module for receiving and transmitting the incident light.

12. The projector of claim 11, wherein the light pipe is a wedge-shaped light pipe.

13. The projector of claim 11, wherein the light pipe, the lens module, the prisms, and the digital micro-mirror device form an optical mechanical system with the magnification of the optical mechanical system being 1.65˜1.85.
